(19) United States
(12) Patent Application Publication
(10) Pub. No.: US 2023/0360486 A1
(43) Pub. Date: Nov. 9, 2023

(54) METHODS AND SYSTEMS FOR SPORTS BETTING

(71) Applicants: Jon Kaplowitz, Wyommising, PA (US); Scot McClintic, Wyomissing, PA (US); Joshua Auriemma, Wyomissing, PA (US)

(72) Inventors: Jon Kaplowitz, Wyommising, PA (US); Scot McClintic, Wyomissing, PA (US); Joshua Auriemma, Wyomissing, PA (US)

(21) Appl. No.: 18/026,265

(22) PCT Filed: Sep. 14, 2021
(86) PCT No.: PCT/US2021/050295

§ 371 Date: Mar. 14, 2023

Related U.S. Application Data
(60) Provisional application No. 63/078,150, filed on Sep. 14, 2020.

(51) Int. Cl. G07F 17/32

(52) U.S. Cl. CPC G07F 17/3288; G07F 17/3211

(57) ABSTRACT

Methods and systems are described for sports betting. A user device (e.g., a mobile device, a smart device, a computing device, etc.) may be configured with a user interface that enables custom teaser bets, randomized parlay bets, standard bets (e.g., moneyline bets, point-spread bets, over-under bets, etc.), and/or the like to be placed for any type of sports competition.

### CROSS-REFERENCE TO RELATED APPLICATIONS

This application claims the benefit of U.S. Provisional Application No. 63/078,150, filed on Sep. 14, 2020. The entire teachings of the above applications are incorporated herein by reference.

### BACKGROUND

Sports betting is a popular way of earning money in a gambling industry that provides entertainment to sports fans and promotes and increases sports viewership. Sports betting involving teaser bets typically have limited point spread options for high scoring sports competitions such as football, basketball, and/or the like. Point spread options are routinely unavailable for low scoring games, such as hockey, baseball, soccer, and/or the like. Limited point spread options for bets and an overall knowledge gap relating to sports betting for novice users (e.g., bettors, etc.) deter users from engaging in sports betting.

It is to be understood that both the following general description and the following detailed description are exemplary and explanatory only and are not restrictive or intended to be limiting. Methods and systems for sports betting are described herein.

A user interface (e.g., a graphical user interface (GUI), a website/webpage, an application, etc.) configured with a user device (e.g., a mobile device, a smart device, a computing device, etc.) enables customized teaser betting, standard sports betting (e.g., betting based on point spreads, moneylines, game totals, etc.), custom parlays, round robin betting, random/quick pick betting, and/or the like. The user interface enables a user (e.g., a bettor, etc.) to combine bets on a wide variety of games and/or sports competitions (e.g., collegiate games, professional games, etc.), such as football games, basketball games, baseball games, soccer games, hockey games, tennis games, volleyball games, boxing and/or martial arts competitions, dart games, games of cricket, lacrosse games, and/or any other type of opponent based game/competition. The user interface may be used to dynamically adjust point spreads for games, partake in an increased quantity of teaser betting options, adjust/move a moneyline setting/wager, and randomly select sports bets.

Teaser bets generally involve three key numbers (e.g., points, etc.) that a user (e.g., bettor, etc.) and/or user device uses to adjust spreads (e.g., forecasts of a number of points by which a stronger/favored sports team is expected to defeat a weaker/underdog sports team, etc.) for bets. For example the numbers 6, 6.5, and 7, may be used for football teasers, and the numbers 4, 4.5, and 5 may be used for basketball teasers. The user interface enables customized teaser betting for any game/sport using any numbers (e.g., points, etc.), for example, numbers (e.g., points, etc.) ranging from 6 to 10.

The user interface enables randomized, “quick pick” style, betting so that a user (e.g., a bettor, etc.) may place bets and receive payouts based on the outcome of one or more sports competitions.

This summary is not intended to identify critical or essential features of the disclosure, but merely to summarize certain features and variations thereof. Other details and features will be described in the sections that follow

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, show examples and together with the description, serve to explain the principles of the methods and systems described herein.

FIG. 1A shows an example system for sports betting.

FIG. 1B shows an example system for sports betting.

FIG. 2 shows an example gaming engine for sports betting.

FIG. 3A shows an example interface for sports betting.

FIG. 3B shows an example interface for sports betting.

FIG. 4 shows an example interface for sports betting.

FIG. 5 shows an example interface for sports betting.

FIG. 6 shows an example interface for sports betting.

FIG. 7 shows an example interface for sports betting.

FIG. 8 shows an example interface for sports betting.

FIG. 9 shows an example interface for sports betting.

FIG. 10 shows an example method for sports betting.

FIG. 11 shows an example method for sports betting.

FIG. 12 shows a block diagram of an example computing device for implementing sports betting.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is to be understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

A user interface (e.g., a graphical user interface (GUI), a website/webpage, an application, etc.) configured with a user device (e.g., a mobile device, a smart device, a computing device, etc.) enables customized teaser betting, standard sports betting (e.g., betting based on point spreads, moneylines, game totals, etc.), custom parlays, round robin betting, random/quick pick betting, and/or the like. The user interface enables a user (e.g., a bettor, etc.) to combine bets on a wide variety of games and/or sports competitions (e.g., collegiate games, professional games, etc.), such as football games, basketball games, baseball games, soccer games, hockey games, tennis games, volleyball games, boxing and/or martial arts competitions, dart games, games of cricket, lacrosse games, and/or any other type of opponent based game/competition. The user interface may be used to dynamically adjust point spreads for games, partake in an increased quantity of teaser betting options, adjust/move a moneyline setting/wager, and randomly select sports bets.

Teaser bets generally involve three key numbers (e.g., points, etc.) that a user (e.g., bettor, etc.) and/or user device uses to adjust spreads (e.g., forecasts of a number of points by which a stronger/favored sports team is expected to defeat a weaker/underdog sports team, etc.) for bets. For example the numbers 6, 6.5, and 7, may be used for football teasers, and the numbers 4, 4.5, and 5 may be used for basketball teasers. The user interface enables customized teaser betting for any game/sport using any numbers (e.g., points, etc.), for example, numbers (e.g., points, etc.) ranging from 6 to 10.

The user interface enables randomized, “quick pick” style, betting so that a user (e.g., a bettor, etc.) may place bets in an expedited manner.

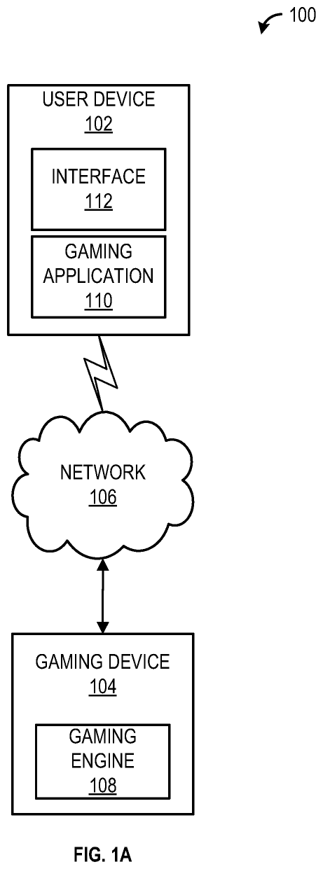

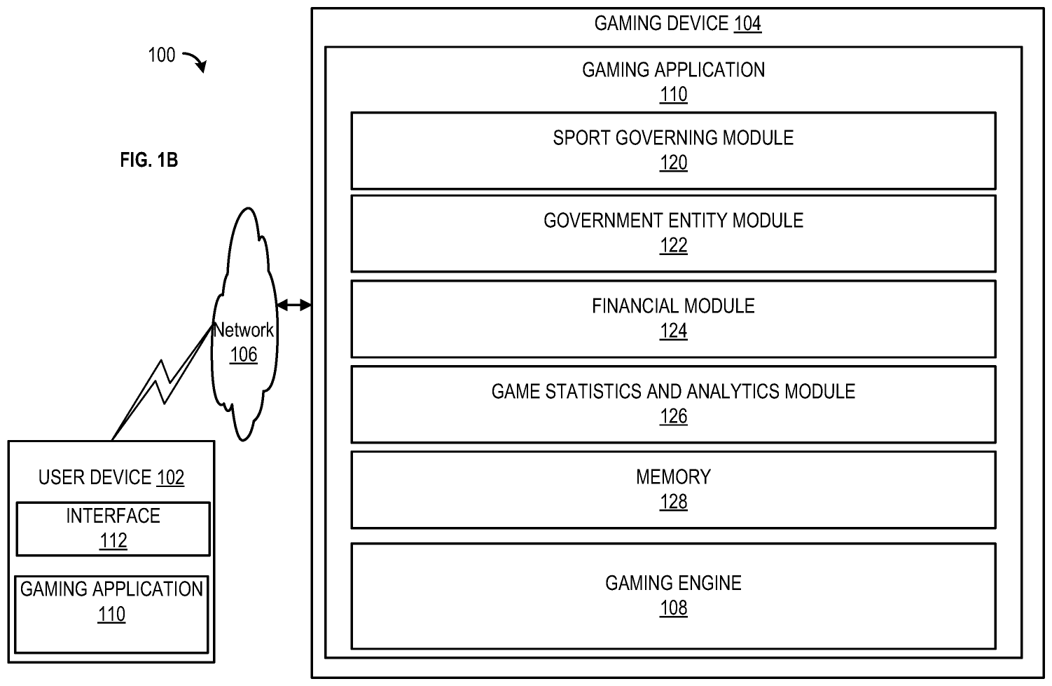

FIGS. 1A-1B show an example system 100 for sports betting. FIG. 1A shows a general representation of the system 100. FIG. 1B shows an expanded representation of the system 100. The system may include a user device 102 (e.g., a mobile device, a smart device, a computing device, etc.) and a gaming device 104 (e.g. a server, a computing device, a cloud device, etc.) in communication with and/or connected to a network 106.

The network 106 may be and/or include a private network, a public network, a secured network, a local area network, a wide area network, Internet, a content (e.g., sports content, gaming content, etc.) access network, a content (e.g., sports content, gaming content, etc.) distribution network, and/or the like. The network 106 may support any wired and/or wireless communication technique. For example, the network 106 may support any long-range communication technique, such as Wi-Fi (IEEE 802.11), BLUETOOTH®, cellular, satellite, infrared, and/or the like. The network 106 may support any suitable short-range communication technique, such as BLUETOOTH®, near-field communication, infrared, and the like.

The user device 102 may include, and/or be configured to run a gaming application 110. The user device 102, for example the gaming application 110, may communicate with the gaming device 104 for sports betting. Although the user device 102 is shown, the system 100 may include any number of user devices.

The user device 101 may comprise an interface 112 that provides an interface to a user to interact with the user device 101, another user device, and/or any other device/component of the system 100. For example, the interface 112 that provide and/or display an interface (e.g., a user interface, etc.) associated with the gaming application 110. The interface 112 may be any interface for presenting and/or receiving information to/from the user, such as user feedback. An interface may be communication interface such as a web browser (e.g., Internet Explorer®, Mozilla Firefox®, Google Chrome®, Safari®, or the like). Other software, hardware, and/or interfaces may be used to provide communication between the user and one or more of the user device 101, another user device, and/or any other device/component of the system 100. The interface 112 may request, receive, and/or query various files from a local source and/or a remote source, such as the gaming application 110 and/or the gaming device 104. The interface 112 may transmit/send data to a local or remote device such as, another user device, and/or any other device/component of the system 100.

The gaming device 104 may include a gaming engine 108 (e.g., a gaming engine, a gaming processor, etc.). The user device 102, for example the gaming application 110, may communicate with the gaming engine 108. In some embodiments, the gaming engine 108 may be resident within the gaming application 110. The user device 102 may be configured to provide updates to the gaming application 110 and the gaming engine 108 resident within the gaming application 110.

The gaming engine 108 may generate odds and/or receive odds (e.g., received from a odds publishing device/system (not shown)) relating to the probability of a win and/or lose for competing sports teams. For example, a sporting events in which a strong/favored team is playing against a weaker/underdog team may cause the gaming engine 108 to generate and/or receive odds (e.g., probable number values, etc.) that suggest/indicate that the strong/favored team will win. The odds may be in the form of a point spread (e.g., a betting line, a line, etc.). For a user, such as a user of the user device 102, to win a bet based on the odds, the strong/favored team must win by a certain amount (or margin) of points and/or the weaker/underdog team must lose by a certain amount less than a specified established margin.

The gaming application 110 enables customized teaser betting (e.g., teaser betting with increased spread options, etc.), standard sports betting (e.g., betting based on point spreads, moneylines, game totals, etc.), custom parlays, round robin betting, random/quick pick betting, and/or the like. For example, the user device 102 may be used for teaser betting. The gaming application 110 may be associated with a user interface (e.g., a graphical user interface (GUI), a website/webpage, an application, etc.), for example, via the interface 112, that includes one or more adjustable elements (e.g., point spread lines, game totals, etc.) that may be adjusted to modify odds of winning and/or losing a sports bet. Teaser bets may be submitted for games where a range of odds may be moved up or down by several points, such as teaser bets associated with football games, basketball games, and/or the like. Teaser bets may also be submitted for games where a range of odds may be moved up or down by a minimal amount of points, such as teaser bets associated with low scoring games like hockey, soccer, baseball, and/or the like.

Teaser bets generally involve three key numbers (e.g., points, etc.) that a user (e.g., bettor, etc.) and/or user device uses to adjust spreads (e.g., forecasts of a number of points by which a stronger/favored sports team is expected to defeat a weaker/underdog sports team, etc.) for bets. For example the numbers 6, 6.5, and 7, are commonly used for football teasers, and the numbers 4, 4.5, and 5 are commonly used for basketball teasers. The gaming application 110 enables customized teaser betting for any game/sport using any numbers (e.g., points, etc.), for example, numbers (e.g., points, etc.) ranging from 6 to 10. Real-time odds validation logic may be used to determine when the odds of winning and/or losing for a particular team are indeterminable based on a given point spread, such as a 7.5 point spread for a football game and/or the like.

The gaming application 110 may, for example, communicate with the gaming engine 108 to perform, for example in real-time, betting conflict analysis to determine when/if one or more bets are conflicting, such as a sports team being wagered against multiple and/or non-existent sports teams. In a sports betting scenario, a conflict (e.g., a conflicting leg/bet, etc.) may occur when two or more bets are correlated or not combinable for a variety of reasons. For example, as user (e.g., bettor, e.g.,) cannot parlay “Team Giants +3” with “Team Giants to Win”, because such outcomes are 1-to-1 correlated outcomes. Notably, if Team Giants wins, the win will always (e.g., 100% of the time, etc.) cover the +3 point spread. Conflicts (e.g., conflicting legs/bets, etc.) in a sports betting scenario may be and/or include system (e.g., the system 100, etc.) and/or gaming (e.g., the gaming application 110, etc.) imposed conflicts, such as conflicts due to risk limitations imposed by a game and/or sports betting facilitator/operator whenever the game and/or sports betting facilitator/operator is uncomfortable with the combinability of one bet with another bet in a parlay. A conflict (e.g., a conflicting leg/bet, etc.) in a sports betting scenario may be caused when/if two bets on opposite sides of a game and/or sports competition are included in a single parlay. For example, if Team Giants (+3) are playing Team Eagles (−3), then a user (e.g., a bettor, etc.) cannot parlay Team Giants +3 with Team Eagles −3 because those legs are in conflict. The gaming application 110 may perform real-time betting conflict analysis to determine and/or indicate any conflict associated with sports betting.

The gaming application 110 enables real-time odds validation logic. For example, the gaming application 110 may determine accuracy and/or validity of any odds (e.g., current odds, etc.) associated with a game and/or sports competition. The gaming application 110 may determine any other attributes (e.g., a dollar value of a maximum bet amount allowed/permitted, etc.) for a game and/or sports competition. The gaming application 110 may use validation logic to ensure the data shown/presented to a user (e.g., a bettor, etc.), for example, via the user interface, is current and/or updated in real-time. The gaming application 110 may validate whether any bet is, or is not, allowed to be combined with any other bet in the form of a parlay bet.

The user device 102 (e.g., the gaming application 110, etc.) enables randomized, “quick pick” style, betting. The user device 102 (e.g., the gaming application 110, etc.) enables a user (e.g., a bettor, etc.) to place bets with a chance for payouts based on the outcome of one or more sports competitions. For example, the user may use the user device 102 (e.g., the gaming application 110, etc.) to indicate a time frame and/or time window. The system 100 may automatically determine one or more sports competitions occurring during the time frame and/or time window. For example, the user may use the user device 102 (e.g., the gaming application 110, etc.) to indicate a time frame and/or time window of seven (7) days. The user device 102 (e.g., the gaming application 110, etc.) may determine a plurality of sports competitions occurring during/within the next seven (7) days. The user may use the user device 102 (e.g., the gaming application 110, etc.) to filter the plurality of sports competitions by indicating and/or selecting a type (or one or more types) of sports competition for sports betting. The user device 102 (e.g., the gaming application 110, etc.) may cause display of the plurality of sports competitions. For example, the user device 102 (e.g., the gaming application 110, etc.) may randomly determine (e.g., quick pick, etc.) a quantity of sports competitions occurring during/within the next seven (7) days. The user device 102 (e.g., the gaming application 110, etc.) may randomly determine any quantity of sports competitions occurring during/within any time frame/window.

The user device 102 (e.g., the gaming application 110, etc.) may be used to select a quantity of sports competitions occurring during/within any time frame/window, such as six (6) sports competitions occurring during/within a next seven (7) days. The user (e.g., bettor, etc.) may use the user device 102 (e.g., the gaming application 110, etc.) to provide a bet/wager amount. The bet/wager amount may be applied as a parlay bet to each of the selected sports competitions.

FIG. 1B shows an expanded representation of the system 100. For example, FIG. 1B shows additional components (e.g., modules, etc.) of the gaming device 104. The gaming device 104 may include the gaming application 110 resident on the user device 102. The gaming application 110 may facilitate and/or support teaser betting, standard sports betting (e.g., betting based on point spreads, moneylines, game totals, etc.), custom parlays, round robin betting, random/quick pick betting, and/or the like. The gaming application 110 may facilitate and/or support a user (e.g., a bettor, etc.) combining bets on a wide variety of games (e.g., collegiate games, professional games, etc.), such as football games, basketball games, baseball games, soccer games, hockey games, tennis games, volleyball games, boxing and/or martial arts competitions, dart games, games of cricket, lacrosse games, and/or any other type of opponent based game.

The gaming application 110 may include one or more modules and/or an engine to facilitate sports betting. For example, the gaming application 110 may include, be associated with, and/or communicate with a sport governing module 120, a government entity module 122, a financial module 124, a game statistics and analytics (GSA) module 126, a memory 128, and the gaming engine 108. In some embodiments, the gaming device 104 and/or gaming application 110 may be configured as and/or with multiple servers, computing devices, cloud devices, gaming devices, and/or the like. For example, in some embodiments, separate heterogeneous servers, computing devices, cloud devices, gaming devices, and/or the like operate to provide each of the sport governing module 120, the government entity module 122, the financial module 124, the GSA module 126, the memory 128, and the gaming engine 108.

The sport governing module 120 may communicate and/or be associated with one or more sports governing entities such as a regional sports federation or confederation, a national sports federation, a sports conference, a sport league (e.g., U.S. and/or International Professional leagues, the National Football League (NFL), the National Basketball Association (NBA), Major League Baseball (MLB), the National Hockey League (NHL), Major League Soccer (MLS), the Premier League, La Liga, the UEFA Champions League, etc.), the International Olympic Committee, a national Olympic committee, an international sports federation, and/or any other sports governing entity.

The sport governing module 120 may, for example via the network 106, communicate with (e.g., exchange data/information, etc.) and/or be associated with one or more computers, servers, systems, and/or the like associated with the one or more sports governing entities. The one or more sports governing entities may use the sport governing module 120 to monitor, regulate, provide data/information, and/or provide oversight for sports betting activities associated with the system 100, such as sports betting activities associated with games, matches, events, activities, competitions, tournaments, and/or the like in a respective sport, country and/or political subdivision, league, conference, and/or the like associated with the one or more sports governing entities.

The government entity module 122 may communicate and/or be associated with one or more government entities such as a national government and/or government entity, a federal government and/or government entity, a regional government and/or government entity, a state government and/or government entity, a provincial government and/or government entity, a local government and/or government entity, a municipal government and/or government entity, and/or any other government/government entity of any political or geographical subdivision. The government entity module 122 may communicate and/or be associated with a gaming commission, a gaming administrator, or any other entity which may regulate, oversee, and/or administer, sports betting activities or sports wagering activities, or any other betting, wagering, gambling, or gaming activities, of any kind or type.

The government entity module 122 may, for example via the network 106, communicate with (e.g., exchange data/information, etc.) and/or be associated with one or more computers, servers, systems, and/or the like associated with the one or more government entities. The one or more government entities, via the government entity module 122, may monitor, regulate, and/or provide for regulating sports betting activities or sports wager activities regarding games, matches, events, or activities, within respective jurisdictions.

The financial module 124 may communicate and/or be associated with one or more financial institutions and/or financial service providers such as bank, a digital wallet and/or digital wallet servicing entity, a credit card company/service, a debit card company/service, a charge card company or service, an electronic money account/service, and/or any other financial institutions and/or financial service provider. The one or more financial institutions and/or financial service providers may administer and/or service one or more financial accounts (e.g., a checking/savings account, a quick cash account, a money market account, etc.), sports betting accounts, gaming accounts, gambling accounts, and/or the like associated with user devices (e.g., the user device 102, etc.), users, entities, sports governing bodies, governmental entities, gaming facilities/venues, information/analytics providers, and/or the like associated with the system 100.

The financial module 124 may communicate and/or be associated with one or more escrow agents and/or escrow facilities managing/holding bets and/or wagers, and any currency, money, finance, objects, commodities, and/or the like subject of, subject to, and/or associated with the bets and/or wagers. The one or more escrow agents and/or escrow facilities may be neutral administrators and/or an officiating party/entity associated with bets and/or wagers. The financial module 124 may, for example via the network 106, communicate with (e.g., exchange data/information, etc.) and/or be associated with one or more computers, servers, systems, and/or the like associated with the one or more financial institutions, financial service providers, escrow agents, and/or escrow facilities.

The GSA module 126 may communicate and/or be associated with one or more data/information sources/providers, such as a news service/outlet, a website, a sportsbook (e.g., Barstool Sports®, etc.), a data analytics service provider, a sports service provider, a sports blog (e.g., a provider of sports predictions, betting recommendations/picks, parlays, etc.), and/or any other data/information sources/providers associated with sports betting activities and/or sports wagering activities of any type and/or kind. The one or more data/information sources/providers may provide information, news, analytics information, sports analytics data/information (e.g., statistical data/information, historical data/information, predictive data/information, forecasting data/information, etc.).

The GSA module 126 may, for example via the network 106, communicate with (e.g., exchange data/information, etc.) and/or be associated with one or more computers, servers, systems, and/or the like associated with the one or more data/information sources/providers. The GSA module 126 receive news, analytics information, sports analytics data/information (e.g., statistical data/information, historical data/information, predictive data/information, forecasting data/information, etc.) and/or the like from the one or more computers, servers, systems, and/or the like associated with the one or more data/information sources/providers.

The memory 128 may include a volatile and/or non-volatile memory. The memory 128 may include and/or be associated with a database. The memory 128 may store, for example, a command and/or data related to components of the gaming device 104, such as the sport governing module 120, the government entity module 122, the financial module 124, the GSA module 126, and/or the gaming engine 108. The memory 128 may store, for example, a command and/or data related to any device/component of the system 100, such as the user device 102.

The memory 128 may include data/information associated with each user and/or user device (e.g., the user device 102, etc.) of the system 100. For example, the memory 128 may include, store, and/or communicate with user information (e.g., a user profile, an account, etc.) associated with each user and/or user device (e.g., the user device 102, etc.) of the system 100 and/or sports betting, gambling, gaming, betting, and/or wagering, activities. The memory 128 may include data/information associated with any sport governing entity, government entity, financial institution, financial service provider, and/or data/information source/provider associated with the system 100.

The memory 128 may include, store, and/or communicate with any/all data/information associated sports betting (e.g., betting history/pattern information, etc.) for each user and/or user device (e.g., the user device 102, etc.). The memory 128 may include, store, and/or communicate with any user profile, sports betting account, gaming account, gambling account, and/or the like associated with the system 100. The memory 128 may include, store, and/or communicate data/information associated with each bet/wager associated with any user profile, sports betting account, gaming account, gambling account, and/or the like associated with the system 100, such as a date and/or time of a bet and/or a sporting event, a game, a match, an activity, a competition, a tournament, and/or the like associated with a bet. Such information may be stored in the database described above. The database may have a particular structure for storing such information and other information. The database may further include a structure.

As described, the gaming engine 108 may generate odds and/or determine odds relating to the probability of a win and/or lose for one or more sports competitions. The gaming engine 108 may generate odds and/or determine odds relating to the probability of a win and/or lose for one or more sports competitions based on data/information received and/or associated with any module and/or component of the gaming device 104. The gaming engine 108 may be configured with one or more application programming interfaces (API) that facilitate sports betting based on communication and/or data/information associated with any module and/or component of the gaming device 104.

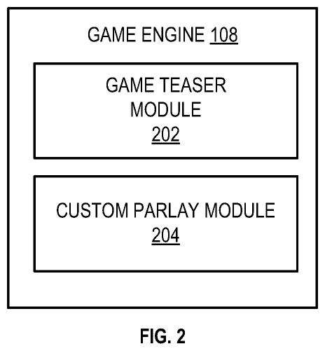

FIG. 2 shows additional components (e.g., modules, etc.) of the gaming engine 108. The gaming engine 108 may include a teaser module 202, and a custom parlay module 204. The teaser module 202 and the custom parlay module 204 enables a user (e.g., a bettor, etc.) of the user device 102 to place teaser bets or parlay bets, respectively, for sports competitions where the user only wins if multiple individual bets are all winning bets. Teaser bets and/or parlay bets may be a combination of any number of individual bets from different, or the same, sports competition. Teaser bets and/or parlay bets may be a combination of betting on the winners of a plurality of different sports competitions. The user (e.g., the bettor, etc.) may bet on each of teams and/or competitor that user supports in each of the respective sports competitions. For example, a user supporting a Team A, a Team B, and a Team C may bet that the Team A, the Team B, and the Team C will each win their respective sports competition. The user will only wins the teaser bets and/or parlay bets if the Team A, the Team B, and the Team C each win the sports competition. Parlay bets may include multiple different bets associated with a sports competition. For example, a user (e.g., a bettor, etc.) may bet that a Team A will win their next sports competition by two points, that a player A will score one point, and a player B will score two points. The user (e.g., the bettor, etc.) only wins the parlay bet if all three individual bets are successful.

The teaser module 202 may communicate with the gaming application 110 associated with the user device 102 to support a user interface. The teaser module 202 enables teaser bets to be placed used point spread values that are routinely unavailable for various sports competitions. The teaser module 202 expands the scope of the type of sports competitions available to be teased. For example, the teaser module 202 enables teaser bets to be placed for sports competitions such as football games, basketball games, baseball games, soccer games, hockey games, tennis games, volleyball games, boxing and/or martial arts competitions, dart games, games of cricket, lacrosse games, and/or any other type of opponent based game/competition.

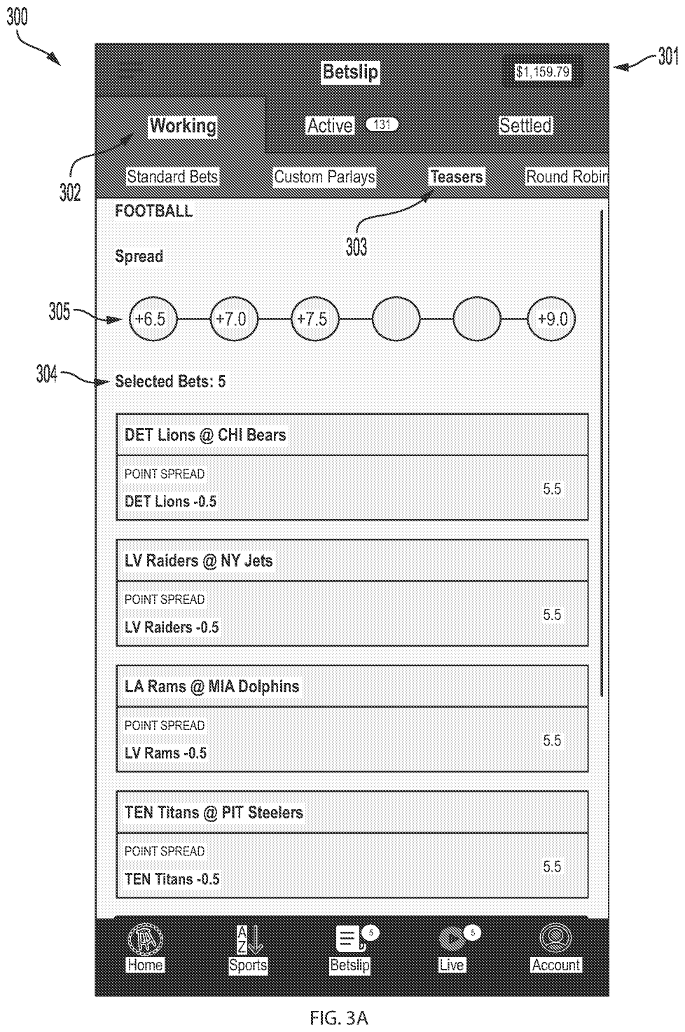

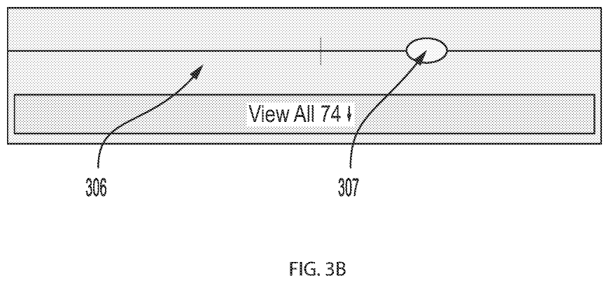

FIG. 3A shows an example screen 300 (e.g., page, area, etc.) of a user interface for sports betting. The user interface may be in communication and/or associated with the teaser module 202. The user device 102 (e.g., the gaming application 110, etc.) may cause output (e.g., display, etc.) of user interface (e.g., the screen 300, etc.). The user interface (e.g., the screen 300, etc.) may be used to view, manage, and submit a variety of sports bets. For example, the user interface enables customized teaser betting (via the teaser module 202), standard sports betting (e.g., betting based on point spreads, moneylines, game totals, etc.), custom parlays, round robin betting, random/quick pick betting, and/or the like.

The screen 300 may include and/or display information associated with user information (e.g., a user profile, an account, etc.) that is associated with the user device 102. For example, an element 301 may indicate a total value and/or dollar amount (e.g., $1,159.79) available in an account (e.g., payment account, betting ledger, etc.) associated with the user device 102 that is available to be used for sports betting.

The screen 300 may include selectable elements (e.g., tabs, etc.) that may be selected to progress to different stages and/or processes in a sports betting scenario. For example, a selectable element 302 (“working”) may be selected to cause display of different types of bets that are be prepared. An element 303 may indicate that a type a bet selected via the user interface is a teaser bet. The user interface enables one or more sports competitions to be selected for betting. An element 304 indicates that five (5) professional football sports competitions (e.g., Detroit Lions v. Chicago Bears, Las Vegas Raiders v. New York Jets, Los Angeles Rams v. Miami Dolphins, and Tennessee Titans v. Pittsburg Steelers) have been selected for betting.

The teaser module 202 enables customized teaser betting (e.g., teaser betting with increased spread options, etc.). Teaser bets typically involve three key numbers (e.g., points, etc.) that a user (e.g., a bettor, etc.) and/or user device uses to adjust spreads (e.g., forecasts of a number of points by which a stronger/favored sports team is expected to defeat a weaker/underdog sports team, etc.) for bets. For example the numbers 6, 6.5, and 7, are commonly used for football teasers, and the numbers 4, 4.5, and 5 are commonly used for basketball teasers. The teaser module 202 enables customized teaser betting for any game/sport using any numbers (e.g., points, etc.) for spreads. Teaser bets may be placed/submitted for games where a range of odds may be moved up or down by several points, such as teaser bets associated with football games, basketball games, and/or the like. Teaser bets may also be submitted for games where a range of odds may be moved up or down by a minimal amount of points, such as teaser bets associated with low scoring games like hockey, soccer, baseball, and/or the like.

A spread line 305 may include a plurality of interactive elements that are each associated with a respective point spread. The spread line 305 enables expanded point spread numbers (e.g., points, etc.) ranging, for example, from 1 to 10 to be selected, via the plurality of interactive elements, and applied to the selected sports competitions. FIG. 3B shows an example spread line 306 that may be included/represented with the user interface, for example via the screen 300. The point spread line 306 may include an interactive element 307. The interactive element 307 may be moved to a plurality of positions along the point spread line 306 (e.g., in a manner similar to a scroll bar, etc.). For example, an interaction, such as a dragging motion (e.g., via a touchscreen, a mouse, a keyboard, and/or the like associated with the user interface, etc.), may cause the interactive element 307 to move to a position of the plurality of positions along the point spread line 306. Each position of the plurality of positions along the point spread line 306 may be associated with a respective point value of a plurality of point values. Causing the interactive element 307 to move to a position of the plurality of positions along the point spread line 306 may cause betting information indicative of the respective point value associated with the position to be associated/applied to the selected sports competitions.

Although, as shown, the spread line 305 is associated with football sports competitions, the teaser module 202 may cause a spread line (e.g., the point spread line 305, the point spread line 306, etc.) with expanded point spread options to be generated for any type of sports competition. The teaser module 202 may support point spreads/number lines for any range of point spread values/points.

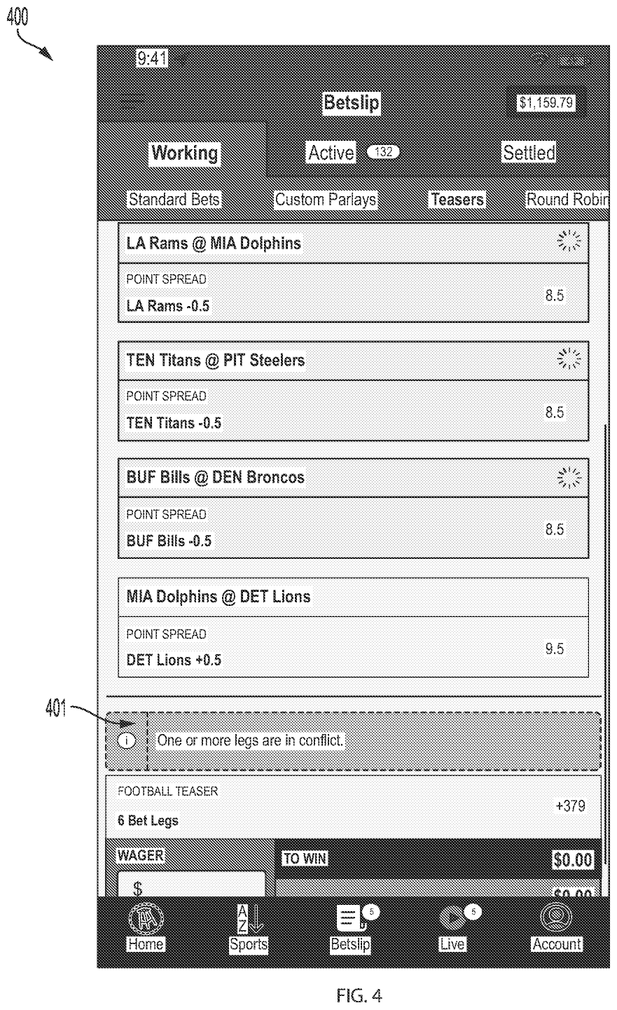

The teaser module 202 and/or the gaming engine 108 to perform, for example in real-time, betting conflict analysis to determine when/if one or more bets are conflicting, such as a sports team being wagered against multiple and/or non-existent sports teams. For example, FIG. 4 shows an example screen 400 (e.g., page, area, etc.) of the user interface for sports betting. The screen 400 may be a continuation (e.g., next screen, etc.) of the screen 300 of FIG. 3. An element 401 may indicate that one or more sports competitions selected for teaser betting are in conflict. For example, a teaser bet on a sports competition between the Miami Dolphins and the Detroit Lions may be in conflict with a teaser bet between the Los Angeles Rams and the Miami Dolphins.

In a sports betting scenario, a conflict (e.g., a conflicting leg/bet, etc.) may occur when two or more bets are correlated or not combinable for a variety of reasons. For example, as user (e.g., a bettor, e.g.,) cannot parlay “Team A (+3)” with “Team A to Win”, because such outcomes are 1-to-1 correlated outcomes. Notably, if Team A wins, the win will always (e.g., 100% of the time, etc.) cover the +3 point spread. Conflicts (e.g., conflicting legs/bets, etc.) in a sports betting scenario may be and/or include system (e.g., the system 100, etc.) and/or gaming (e.g., the gaming application 110, etc.) imposed conflicts, such as conflicts due to risk limitations imposed by a game and/or sports betting facilitator/operator whenever the game and/or sports betting facilitator/operator is uncomfortable with the combinability of one bet with another bet in a parlay. A conflict (e.g., a conflicting leg/bet, etc.) in a sports betting scenario may be caused when/if two bets on opposite sides of a game and/or sports competition are included in a single parlay. For example, if Team A (+3) are playing Team B (−3), then a user (e.g., bettor) cannot parlay Team A+3 with Team B (−3) because those legs are in conflict. The gaming application 110 may perform real-time betting conflict analysis to determine and/or indicate any conflict associated with sports betting.

The teaser module 202 may cause the user interface to generate an audible notification to indicate the conflict highlighted by element 401.

Returning to FIG. 2, the custom parlay module 204 may communicate with the gaming application 110 associated with the user device 102 to support the user interface. The custom parlay module 204 enables randomized, “quick pick” style, betting. The custom parlay module 204 enables a user (e.g., a bettor, etc.) of the user device 102, such as a user to place bets with a chance for payouts based on the outcome of one or more sports competitions.

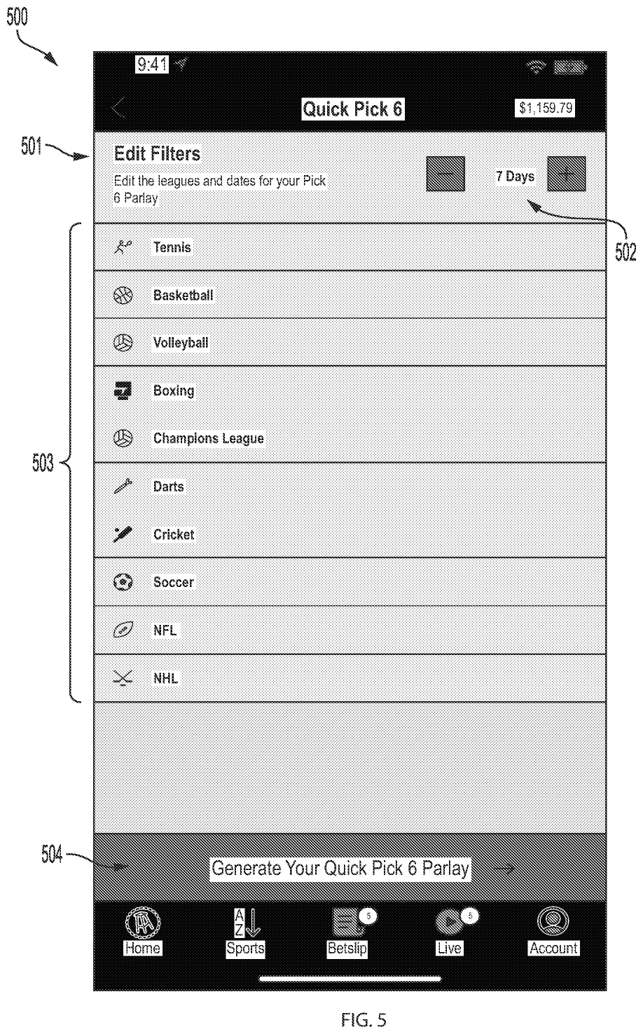

FIG. 5 shows an example screen 500 (e.g., page, area, etc.) of the user interface for sports betting. The screen 500 may be used to apply one or more filters to a randomized query for sports competitions. An element 501 indicates that one or more filters to be applied to a randomized query of sports competitions. An interactive element 502 may be selected and/or interacted with to indicate a time frame and/or time window. As shown, a time frame and/or time window of seven (7) days is selected. An interactive element 503 indicates additional filter elements that may be selected to include types of sports competitions (e.g., tennis, basketball, volleyball, boxing, champions league, darts, cricket, soccer, NFL football, NHL hockey, etc.) in the randomized query for sports competitions. Once filters have been set (e.g., elements 501 and 503, etc.) an interactive element 504 may be selected to initiate the randomized query for sports competitions and generate a parlay bet (e.g., a quick pick 6 parlay, etc.)

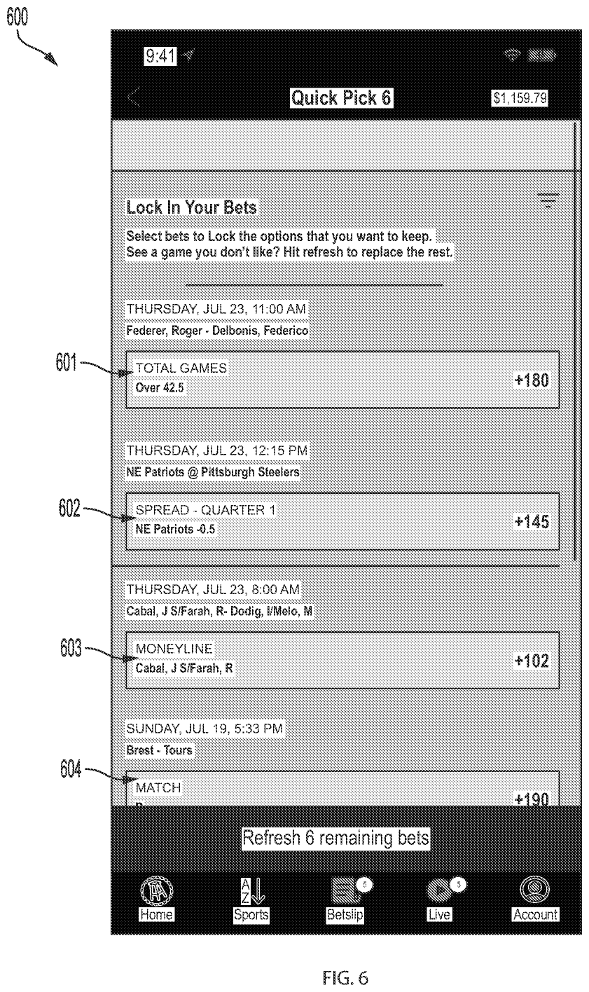

FIG. 6 shows an example screen 600 (e.g., page, area, etc.) of the user interface for sports betting. The screen 600 may be a continuation (e.g., next screen, etc.) of the screen 500 of FIG. 5. The screen 600 may be a confirmation screen that enables a user of the user device 102 to confirm the sports competitions for which a randomized parlay bet may be submitted/placed. The screen 600 may indicate dates and times associated with the randomly determined sports competitions, and the types of bets (e.g., total bets (under-over), point spread bets, moneyline bets, match bets, etc.) being placed for each randomly determined sports competition. Interactive elements 601-604 may be selected and/or interacted with to confirm the sports competitions for which a randomized parlay bet may be submitted/placed.

For example, the user may use the user device 102 (e.g., the gaming application 110, etc.) to indicate a time frame and/or time window of seven (7) days. The user device 102 (e.g., the gaming application 110, etc.) may determine a plurality of sports competitions occurring during/within the next seven (7) days. The user may use the user device 102 (e.g., the gaming application 110, etc.) to filter the plurality of sports competitions by indicating and/or selecting a type (or one or more types) of sports competition for sports betting. The user device 102 (e.g., the gaming application 110, etc.) may cause display of the plurality of sports competitions. For example, the user device 102 (e.g., the gaming application 110, etc.) may randomly determine (e.g., quick pick, etc.) a quantity of sports competitions occurring during/within the next seven (7) days. The user device 102 (e.g., the gaming application 110, etc.) may randomly determine any quantity of sports competitions occurring during/within any time frame/window. The user device 102 (e.g., the gaming application 110, etc.) may randomly determine any quantity of sports competitions associated with a particular sports league and/or game type (e.g., NFL sports competitions, etc.) occurring during/within any time frame/window. The user device 102 (e.g., the gaming application 110, etc.) may randomly determine any quantity of sports competitions associated with multiple sports leagues and/or game types (e.g., NFL sports competitions, NHL sports competitions, NBA sports competitions, MLB sports competitions, NASCAR sports competitions, UFC sports competitions, US Chess Federation sports competitions, Olympic sports competitions, etc.) occurring during/within any time frame/window.

The custom parlay module 204 enables any randomly determined sports competitions to be selected by a user (e.g., a bettor, etc.) to be selected for a parlay bet. The custom parlay module 204 may determine any number of randomized sports competitions, and the user (e.g., a bettor, etc.) may select desired sports completions from the randomized sports competitions, and cause the custom parlay module 204 to determine new randomized sports competitions for any sports competitions that are not selected. For example, custom parlay module 204 may continuously generate an output of randomized sports competitions until a user (e.g., a bettor, etc.) is satisfied with the outcome and/or selection options.

The user device 102 (e.g., the gaming application 110, etc.) may be used to select a quantity of sports competitions occurring during/within any time frame/window, such as six (6) sports competitions occurring during/within a next seven (7) days. The user (e.g., the bettor, etc.) may use the user device 102 (e.g., the gaming application 110, etc.) to provide a bet/wager amount. The bet/wager amount may be applied as a parlay bet to each of the selected sports competitions.

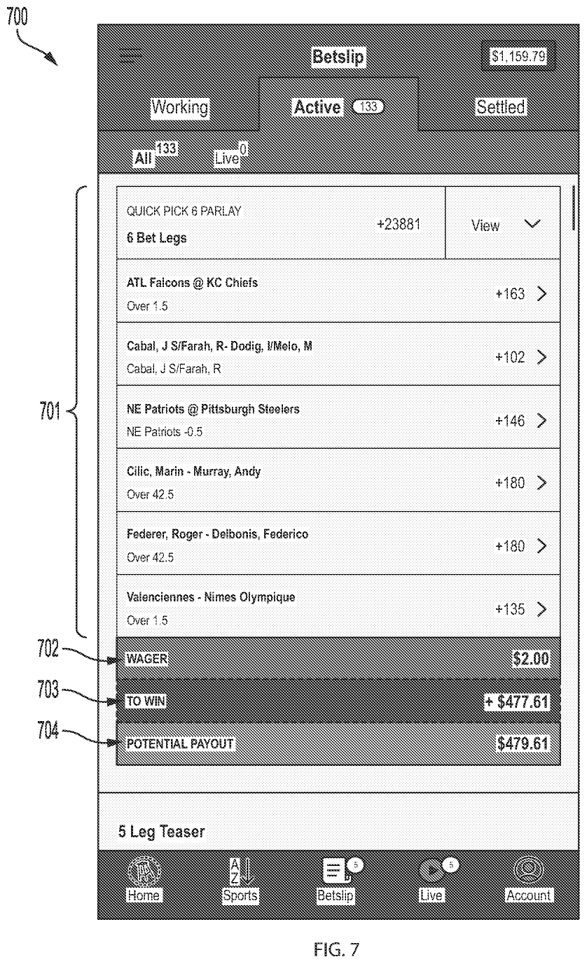

FIG. 7 shows an example screen 700 (e.g., page, area, etc.) of the user interface for sports betting. The screen 700 may be a continuation (e.g., next screen, etc.) of the screen 600 of FIG. 6. The screen 700 may show the selected sports competitions (element 701), a wager/bet amount (element 702), a potential value of funds to be won (element 704), a total payout amount (element 705).

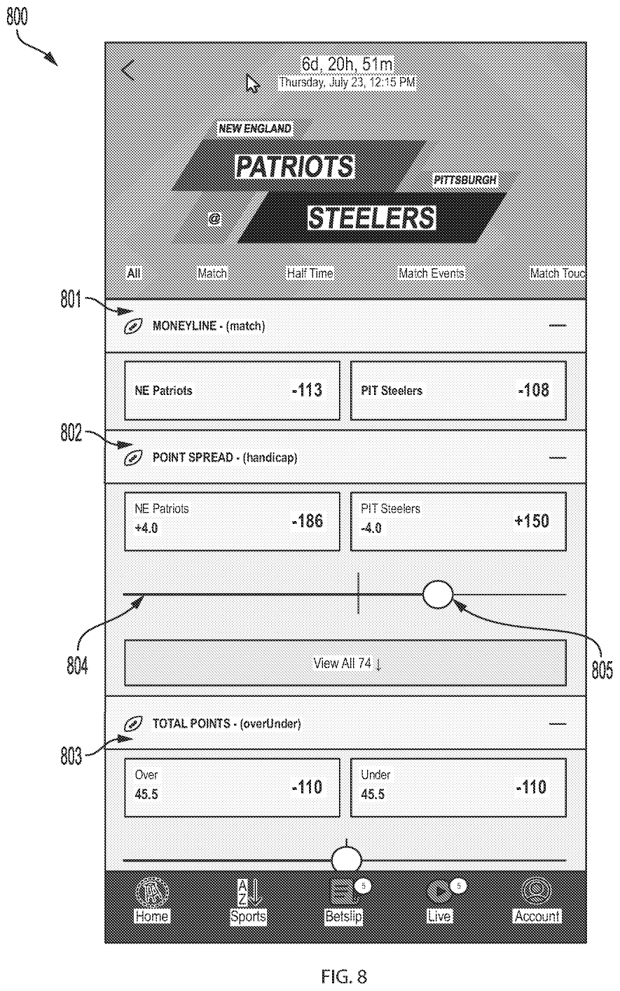

The user interface for sports betting may include additional screens that provide data/information associated with sports betting. FIG. 8 shows an example screen 800 (e.g., page, area, etc.) of the user interface for sports betting. The screen 800 shows additional types of bets that may be placed for a sports competition. As shown a sports competition between the New England Patriots and the Pittsburg Steelers has been selected. The screen 800 may include data/information for each type of bet, such as a moneyline bet (element 801), a point spread bet (element 802), and a total points and/or over-under bet (element 803).

The screen 800 may include a spread line 804 that may be included/represented with the user interface. The point spread line 804 may include an interactive element 805. The interactive element 307 may be moved to a plurality of positions along the point spread line 306. For example, an interaction, such as a dragging motion (e.g., via a touchscreen, a mouse, a keyboard, and/or the like associated with the user interface, etc.), may cause the interactive element 307 to move to a position of the plurality of positions along the point spread line 306. Each position of the plurality of positions along the point spread line 306 may be associated with a respective point value of a plurality of point values. Causing the interactive element 307 to move to a position of the plurality of positions along the point spread line 306 may cause betting information indicative of the respective point value associated with the position to be associated/applied to the selected sports competitions.

As an example, the interactive element 805 may be moved across the point spread line 306 by a user. As the interactive element 805 is moved, the respective point values are updated on the interface.

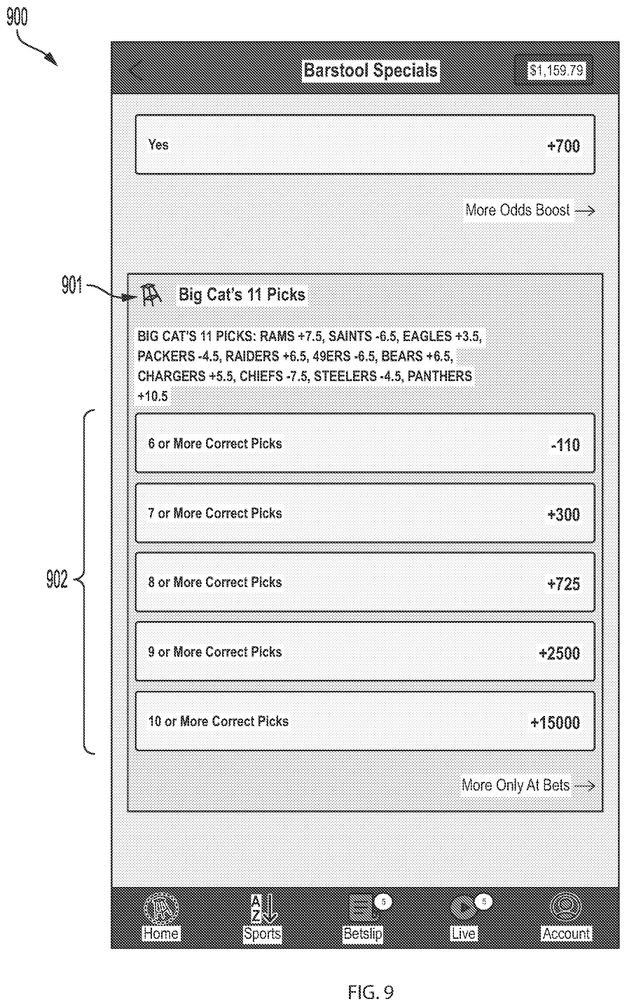

FIG. 9 shows an example screen 900 (e.g., page, area, etc.) of the user interface for sports betting. Data/information from a sportsbook (e.g., Barstool Sports®, etc.) and/or the like may be used to recommend/suggest bets for sports competitions. For example, the screen 900 may display (element 901) a quantity of recommended sports competitions and associated point spreads.

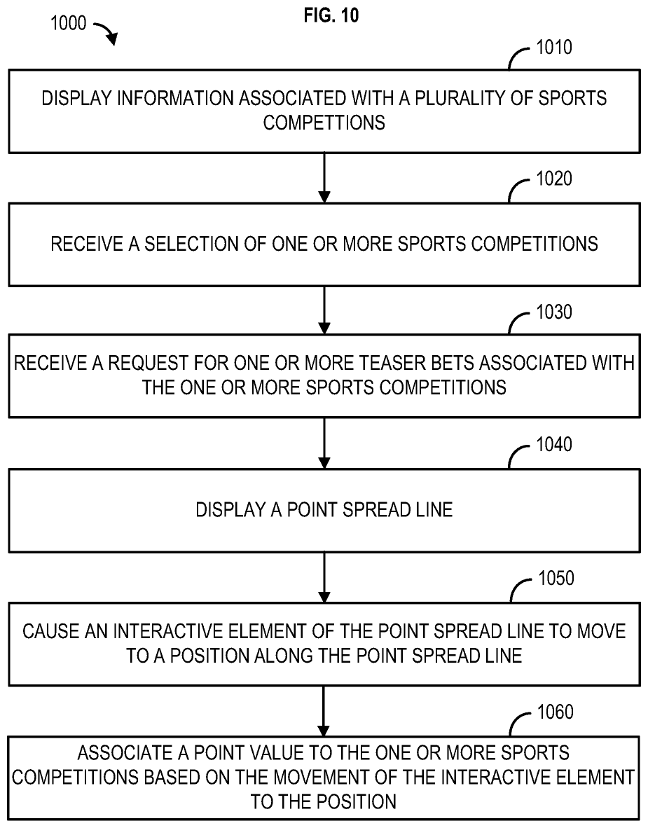

FIG. 10 shows an example method 1000 for sports betting. At 1010, a user device (e.g., a mobile device, a smart device, a computing device, etc.) may display of information associated with a plurality of sports competitions. The sports competitions may include, for example, football games, basketball games, baseball games, soccer games, hockey games, tennis games, volleyball games, boxing and/or martial arts competitions, dart games, games of cricket, lacrosse games, and/or the like. The user device may be configured with an application and/or software that causes the user device to display a user interface. The user interface may be associated with a gaming engine associated with a network device (e.g. a gaming device, a server, a computing device, a cloud device, etc.).

At 1020, a selection of one or more sports competitions of the plurality of sports competitions may be received. The selection of the one or more sports competitions may be received based on an interaction with one or more interactive elements of the user interface. The selection of the one or more sports competitions may be received based on a recommendation of at least one sports competition of the one or more sports competitions. The recommendation may be from a sportsbook (e.g., Barstool Sports®, etc.) and/or the like.

At 1030, a request for one or more teaser bets associated with the one or more sports competitions may be received. The request for one or more teaser bets may be received via and/or from the user interface and/or user device. The one or more teaser bets may be associated with a type of bet of a plurality of types of bets that may be selected via the user interface. The plurality of types of bets may include one or more of: teaser bets, parlay bets, moneyline bets, point-spread bets, and over-under bets. The request for one or more teaser bets may sent to the network device (e.g. a gaming device, a server, a computing device, a cloud device, etc.).

At 1040, the user device may display a point spread line. The user interface may be used to display the point spread line. The user device may display the point spread line based on data/information received from the network device, such as game statistics, and/or the like. Teaser bets generally involve three key numbers (e.g., points, etc.) that a user (e.g., a bettor, etc.) and/or user device uses to adjust spreads (e.g., forecasts of a number of points by which a stronger/favored sports team is expected to defeat a weaker/underdog sports team, etc.) for bets. For example the numbers 6, 6.5, and 7, are commonly used for football teasers, and the numbers 4, 4.5, and 5 are commonly used for basketball teasers. The user interface enables customized teaser betting for any game/sport using any numbers (e.g., points, etc.), for example, numbers (e.g., points, etc.) ranging from 6 to 10. For example, the point spread line with each position of a plurality of positions along the point spread line associated with a respective point value of a plurality of point values may be generated and/or displayed. Each position of the plurality of positions may be associated with a respective point value of a plurality of point values. The plurality of point values may range from a value of six to a value of ten, and the plurality of point values may be each separated by a value of half of a point (e.g., 6, 6.5, 7, 7.5, 8, 8.5, 9, 9.5, 10, etc.). The plurality of point values may range from any point value to any other point value. The point spread line may include an interactive element that may be moved to a position of the plurality of positions.

In some instances, the point spread line may include a plurality of interactive elements. Each interactive element of the plurality of interactive elements may be associated with a respective point value of a plurality of point values. The plurality of point values may range from a value of six to a value of ten, and the plurality of point values may be each separated by a value of half of a point (e.g., 6, 6.5, 7, 7.5, 8, 8.5, 9, 9.5, 10, etc.). The plurality of point values may range from any point value to any other point value.

At 1050, the interactive element may move to a position of the plurality of positions. for example, an interaction, via the user interface, with the interactive element may cause the interactive element to move (e.g., slide, etc.) to a position of the plurality of positions. For example, an interaction with a touch screen associated with the user interface, a dragging motion via a mouse/keyboard associated with the user interface, and/or the like may cause the interactive element to move to a position of the plurality of positions.

At 1060, betting information indicative of the respective point value of the plurality of point values associated with the position of the plurality of positions (and/or the selected interactive element of the plurality of interactive elements) may be associated with the one or more sports competitions. For example, the betting information (e.g., a point spread value, etc.) associated with the position of the plurality of positions (and/or the selected interactive element of the plurality of interactive elements) may be associated with the one or more sports competitions based on a selected interactive element of the plurality of interactive elements. Based on the betting information and at least one outcome of the one or more sports competitions, funds (e.g., a payout, etc.) may be received in an account associated with a user device, or funds to be removed from the account (e.g., in the event of a betting loss, etc.).

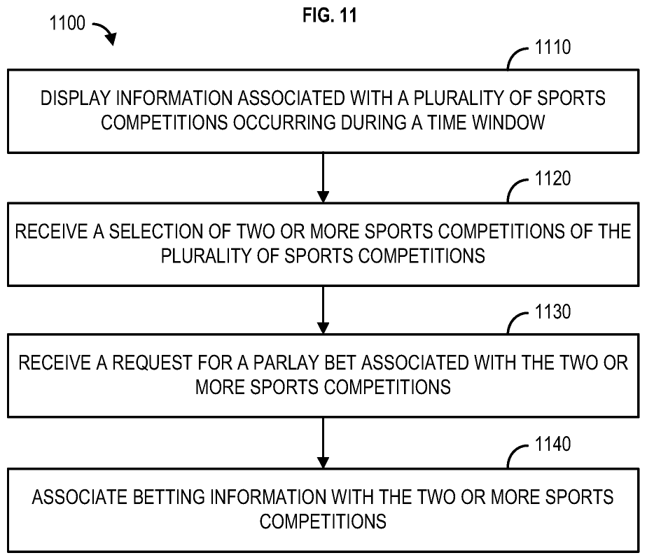

FIG. 11 shows an example method 1100 for sports betting. At 1110, a user device (e.g., a mobile device, a smart device, a computing device, etc.) may display information associated with a plurality of sports competitions occurring within a time window. The sports competitions may include, for example, football games, basketball games, baseball games, soccer games, hockey games, tennis games, volleyball games, boxing and/or martial arts competitions, dart games, games of cricket, lacrosse games, and/or the like. The user device may be configured with an application and/or software that causes the user device to display a user interface. The user interface may be associated with a gaming engine associated with a network device (e.g. a gaming device, a server, a computing device, a cloud device, etc.). The user device may display the information associated with the plurality of sports competitions via the user interface.

The user device, via the user interface, may be used to indicate a time frame and/or time window, such as a time window of seven (7) days. A plurality of sports competitions occurring during/within the next seven (7) days may be determined. The plurality of sports competitions may be determined based on the time window a start time associated with each sports completion of the plurality of sports indicating when the respective sports competition will occur. The user interface may be used to filter the plurality of sports competitions by indicating and/or selecting a type (or one or more types) of sports competition for sports betting.

At 1120, a selection of two or more sports competitions of the plurality of sports competitions may be received. Receiving the selection of the two or more sports competitions may include receiving the selection of the two or more sports competitions based on an interaction with one or more interactive elements of the user interface.

At 1130, a request for a parlay bet associated with the two or more sports competitions and a wager amount associated with the parlay bet may be received. Receiving the request for the parlay bet may include receiving the request for the parlay via the user interface.

At 1140, based on the wager amount, betting information indicative of a respective payout value of the plurality of payout values may be associated with each sports competition of the two or more sports competitions. Based on the betting information and at least one outcome of the two or more sports competitions, funds may be received in an account associated with the user device or funds may be removed from the account.

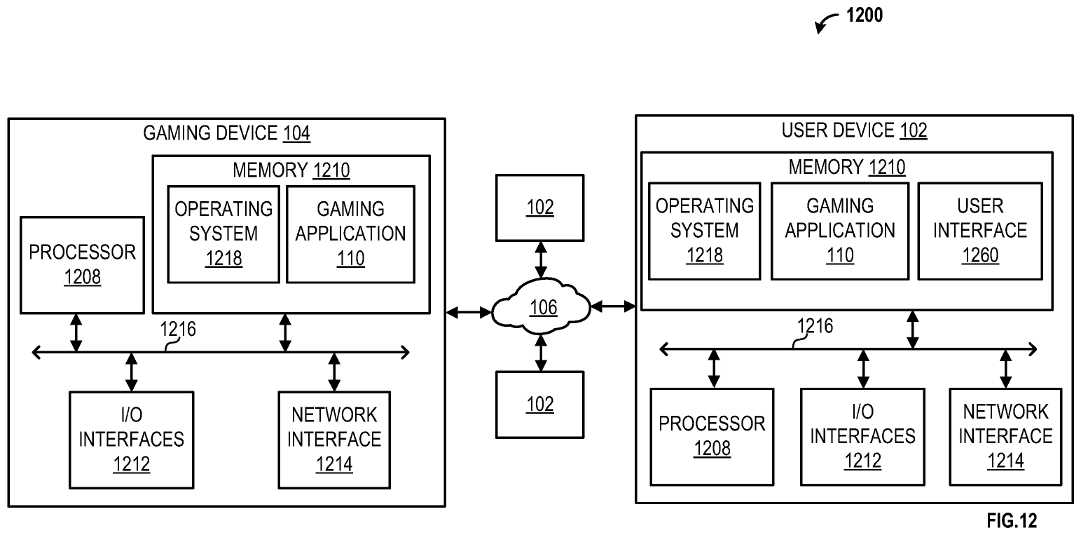

FIG. 12 is a block diagram depicting an environment 1200 comprising non-limiting examples of the gaming device 104 and the user device 102 connected through the network 106. In an aspect, some or all steps of any described method may be performed on a computing device as described herein. The gaming device 104 may comprise one or multiple computers configured to store one or more of the gaming application 110, one or more modules of the application 110, and/or an engine of the gaming application 110. For example, the gaming device 104 may include the sport governing module 120, the government entity module 122, the financial module 124, the game statistics and analytics (GSA) module 126, the memory 128, the gaming engine 108, and/or the like. The user device 102 may comprise one or multiple computers configured to store one or more of the gaming application 110 to operate the user interface 1260 (e.g., screens 300-900, etc.) (e.g., via a web browser, API, etc.). Multiple user devices 102 may connect to the gaming device 104 through the network 106 such as, for example, the Internet. A user on a user device 102 may connect to the gaming application 110 via the user interface 1260 (e.g., screens 300-900, etc.). In an aspect, one or more of the gaming application 114, the sport governing module 120, the government entity module 122, the financial module 124, the game statistics and analytics (GSA) module 126, the memory 128, and the gaming engine 108 may be resident on the user device 102.

The gaming device 104 and the user device 102 may be a digital computer that, in terms of hardware architecture, generally includes a processor 1208, memory system 1210, input/output (I/O) interfaces 1212, and network interfaces 1214. These components (1208, 1210, 1212, and 1214) are communicatively coupled via a local interface 1216. The local interface 1216 may be, for example but not limited to, one or more buses or other wired or wireless connections, as is known in the art. The local interface 1216 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1208 may be a hardware device for executing software, particularly that stored in memory system 1210. The processor 1208 may be any custom made or commercially available processor, a central processing unit (CPU), an auxiliary processor among several processors associated with the gaming device 104 and the user device 102, a semiconductor-based microprocessor (in the form of a microchip or chip set), or generally any device for executing software instructions. When the gaming device 104 and user device 102 are in operation, the processor 1208 may be configured to execute software stored within the memory system 1210, to communicate data to and from the memory system 1210, and to generally control operations of the gaming device 104 and the user device 102 pursuant to the software.

The I/O interfaces 1212 may be used to receive user input from and/or for providing system output to one or more devices or components. User input may be provided via, for example, a keyboard and/or a mouse. System output may be provided via a display device and a printer (not shown). I/O interfaces 1212 may include, for example, a serial port, a parallel port, a Small Computer System Interface (SCSI), an IR interface, an RF interface, and/or a universal serial bus (USB) interface.

The network interface 1214 may be used to transmit and receive from the gaming device 104 or the user device 102 on the network 106. The network interface 1214 may include, for example, a 10BaseT Ethernet Adaptor, a 100BaseT Ethernet Adaptor, a LAN PHY Ethernet Adaptor, a Token Ring Adaptor, a wireless network adapter (e.g., Wi-Fi), or any other suitable network interface device. The network interface 1214 may include address, control, and/or data connections to enable appropriate communications on the network 106.

The memory system 1210 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 1210 may incorporate electronic, magnetic, optical, and/or other types of storage media. Note that the memory system 1210 may have a distributed architecture, where various components are situated remote from one another, but may be accessed by the processor 1208.

The software in memory system 1210 may include one or more software programs, each of which comprises an ordered listing of executable instructions for implementing logical functions. In the example of FIG. 12, the software in the memory system 1210 of the gaming device 104 may comprise the gaming application 110 (or subcomponents thereof) and a suitable operating system (O/S) 1218. In the example of FIG. 12, the software in the memory system 1210 of the user device 102 may comprise the user interface 1260 (, the gaming application 110, and a suitable operating system (O/S) 1218. The operating system 1218 essentially controls the execution of other computer programs, such as the operating system 1218, the gaming application 110, the gaming application 114, and/or the user interface 1260, and provides scheduling, input-output control, file and data management, memory management, and communication control and related services.

For purposes of illustration, application programs and other executable program components such as the operating system 1218 are illustrated herein as discrete blocks, although it is recognized that such programs and components may reside at various times in different storage components of the gaming device 104 and/or the user device 102. An implementation of the gaming application 110, the gaming application 114, and/or the user interface 1260 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
causing display of information associated with a plurality of sports competitions;
receiving a selection of one or more sports competitions of the plurality of sports competitions;
receiving a request for one or more teaser bets associated with the one or more sports competitions;
causing, based on the request for the one or more teaser bets, display of a point spread line comprising an interactive element, wherein each position of a plurality of positions along the point spread line is associated with a respective point value of a plurality of point values;
causing, based on an interaction with the interactive element, the interactive element to move to a position of the plurality of positions; and
associating, based on the interactive element moving to the positon, betting information indicative of the respective point value associated with the position with the one or more sports competitions.

2. The method of claim 1, wherein causing display of the information associated with the plurality of sports competitions comprises causing a user device to display the information associated with the plurality of sports competitions via a user interface.

3. The method of claim 2, wherein the user device comprises one or more of: a mobile device, a smart device, and a computing device.

4. The method of claim 1, wherein receiving the selection of the one or more sports competitions comprises receiving the selection of the one or more sports competitions based on an interaction with one or more interactive elements of a user interface.

5. The method of claim 1, wherein receiving the selection of the one or more sports competitions comprises receiving the selection based on a recommendation of at least one sports competition of the one or more sports competitions.

6. The method of claim 1, wherein receiving the request for the one or more teaser bets comprises receiving the request for the one or more teaser bets via a user interface.

7. The method of claim 1, wherein the one or more teaser bets are associated with a type of bet of a plurality of types of bets that may be selected via a user interface.

8. The method of claim 7, wherein the plurality of types of bets comprise one or more of: teaser bets, parlay bets, moneyline bets, point-spread bets, and over-under bets.

9. The method of claim 1, wherein the plurality of point values range from a value of six to a value of ten, wherein the plurality of point values are each separated by a value of half of a point.

10. The method of claim 1, further comprising causing, based on the betting information and at least one outcome of the one or more sports competitions, funds to be received in an account associated with a user device or funds to be removed from the account.

11. A method comprising:
causing display of information associated with a plurality of sports competitions occurring within a time window;
receiving a selection of two or more sports competitions of the plurality of sports competitions;
receiving a request for a parlay bet associated with the two or more sports competitions, and a wager amount associated with the parlay bet; and
associating, based on the wager amount, betting information indicative of a respective payout value of a plurality of payout values with each sports competition of the two or more sports competitions.

12. The method of claim 11, wherein causing display of the information associated with the plurality of sports competitions comprises causing a user device to display the information associated with the plurality of sports competitions via a user interface.

13. The method of claim 12, wherein the user device comprises one or more of: a mobile device, a smart device, and a computing device.

14. The method of claim 11, wherein receiving the selection of the two or more sports competitions comprises receiving the selection of the two or more sports competitions based on an interaction with one or more interactive elements of a user interface.

15. The method of claim 11, wherein receiving the request for the parlay bet comprises receiving the request for the parlay via a user interface.

16. The method of claim 11, further comprising receiving, from a user device, an indication of the time window.

17. The method of claim 11, further comprising determining, based on the time window a start time associated with each sports completion of the plurality of sports competitions, the plurality of sports competitions.

18. The method of claim 11, further comprising causing, based on the betting information and at least one outcome of the two or more sports competitions, funds to be received in an account associated with a user device or funds to be removed from the account.

19. One or more computer-readable media storing processor-executable instructions that, when executed by at least one processor, cause the at least one processor to:
cause display of information associated with a plurality of sports competitions;
receive a selection of one or more sports competitions of the plurality of sports competitions;
receive a request for one or more teaser bets associated with the one or more sports competitions;
cause, based on the request for the one or more teaser bets, display of a point spread line comprising a plurality of interactive elements, wherein each interactive element of the plurality of interactive elements is associated with a respective point value of a plurality of point values; and
associate, based on a selected interactive element of the plurality of interactive elements, betting information indicative of the respective point value of the plurality of point values associated with the selected interactive element with the one or more sports competitions.

20. (canceled)
